(19) United States
(12) Patent Application Publication
(10) Pub. No.: US 2006/0073308 A1
(43) Pub. Date: Apr. 6, 2006

(54) Method of partially engraving foamed plastic extrusions and extrusions so engraved

(75) Inventor: Angelo Sudano, Broisbriand (CA)

Correspondence Address: DENNISON ASSOCIATES, 133 RICHMOND STREET WEST, SUITE 301, TORONTO, ON, M5H 2L7, CA

(73) Assignee: Royal Group Technologies Limited

(21) Appl. No.: 11/056,109

(22) Filed: Feb. 14, 2005

(30) Foreign Application Priority Data
Sep. 23, 2004 (CA) 2,482,500

(51) Int. Cl. B32B 3/00; B29C 44/46

(52) U.S. Cl. 428/156; 264/51; 264/284

(57) ABSTRACT

A method of only partially engraving foamed plastic extrusions and foamed plastic extrusions so engraved, the method comprising formulating the plastic to leave residual foaming agents after extrusion and contacting one or both sides of the extrusion with an embossed engraving roller or rollers controlled to limit penetration and contact of the foamed plastic with the outer portions only of the roller embossment to activate residual foaming agents to foam the plastic around such penetrating portions.

### FIELD OF THE INVENTION

This invention relates to the art of engraving foamed plastic extrusions.

More particularly, the invention relates to providing foamed plastic extrusions such as blind slats or the like which are only partially engraved to uniquely present decorative designs or patterns which occupy only a portion of their width.

### BACKGROUND OF THE INVENTION

While foamed plastic extrusions such as blind slats louvers, frames, trim strips and the like have heretofore been engraved with decorative designs, it has been a requirement that the full surface of the extrusions be engraved to preclude their distortion and impairment of their surfaces and density where they have not been engraved. These problems have precluded the highly desirable decorative effect which it has been found can be obtained by only partially engraving these extrusions in such a way as to provide designs occupying only a portion of their width while leaving their surfaces and density where they have not been engraved unimpaired.

It is therefore the object of the present invention to solve the problems of only partially engraving foamed plastic extrusions.

It is a further object of the invention to enable the designs or patterns created by the partial engraving of the extrusions to be located at any position or positions between their width and to enable such partial engravings to be effected on the upper side or the lower side or on both the upper and lower sides of the extrusion whereby an infinite number of novel designs by partial extrusion can be obtained.

### SUMMARY OF THE PRESENT INVENTION

The invention resides in providing an engraving roller having the desired design embossed on a portion of its width, penetrating a foamed plastic extrusion formulated to have residual activatable foaming agents with the roller embossment which has been heated to a temperature of the order of 230 degrees F. to 300 degrees F. sufficient to activate the residual foaming agents.

Penetration of the roller embossment is arranged to be limited so that only the outer portions thereof penetrate the foamed plastic of the extrusion. With this arrangement, the outer portions of the roller embossment cause the residual foaming agents to foam the plastic to precisely conform to the penetrating outer portions of the roller embossment leaving the remainder, that is, the non-engraved portions of the extrusion unaltered.

According to one aspect of the invention the heating of the roller embossment is effected by a hot air gun or guns. Alternatively, the roller itself may be heated by circulating hot oil to bring the embossment up to the required foaming agents activating temperature. In both cases, of course, only the outer portions of the roller embossment penetrate the foamed plastic of the extrusion.

It will be understood that since only the outer portions of the embossment of the roller penetrate the foamed plastic of the extrusion a space will be left in the valleys of the roller embossment for the escape of heat.

If the embossment on the roller is adjacent one side as opposed to being centrally located there may be a tendency to effect the straightness of the extrusion during the engraving operation and accordingly to correct this potential problem following the engraving the extrusion is preferably heated to a temperature of the order of about 150 degrees F. to 200 degrees F. This heating temperature is below any blowing agent activation temperature but softens the extrusion so that an operator can readily correct any distortion thereof as the extrusion is pulled to a cutting table where it can be cut off at the proper lengths.

These and other objects and features will be apparent from the following detailed description taken in conjunction with the accompanying drawings.

### BRIEF DESCRIPTION OF THE DRAWINGS

FIG. 1 is a simplified perspective view of an extruder showing a generally flat extruded strip of foamed plastic being pulled from the extruder through an extrusion die, a calibrator, and a vacuum operated water cooling station;

FIG. 2 shows the foamed plastic extrusion being pulled through the engraving station by the puller after which it is fed through a cutting station onto a collecting table;

FIG. 3 is an enlarged broken away view of the engraving roller embossed with a design showing the outer portions of the embossment penetrated into the foamed plastic of the extrusion to the maximum depth to which they are limited so that all other roller surfaces are maintained out of contact with the extrusion;

FIG. 3A shows the bottom roller 12 of FIG. 3 replaced by an engraving roller 12′ having a design the same as design 15 embossed thereon;

FIG. 4 is a fragmented section of the roller after the outer portions of the embossment have left the extrusion showing the extrusion grooved or engraved with an accurate reproduction of the roller embossment design;

FIG. 5 is a plan view of the extrusion after it has been engraved;

FIG. 6 is a cross section view taken along lines 6-6 of FIG. 5;

FIG. 7 is an elevational view of an alternative engraving station in which the engraving roller is heated with circulating oil; and FIG. 8 is a perspective view of the roller arrangement in FIG. 7.

### DETAILED DESCRIPTION ACCORDING TO THE PREFERRED EMBODIMENTS OF THE PRESENT INVENTION IN WHICH

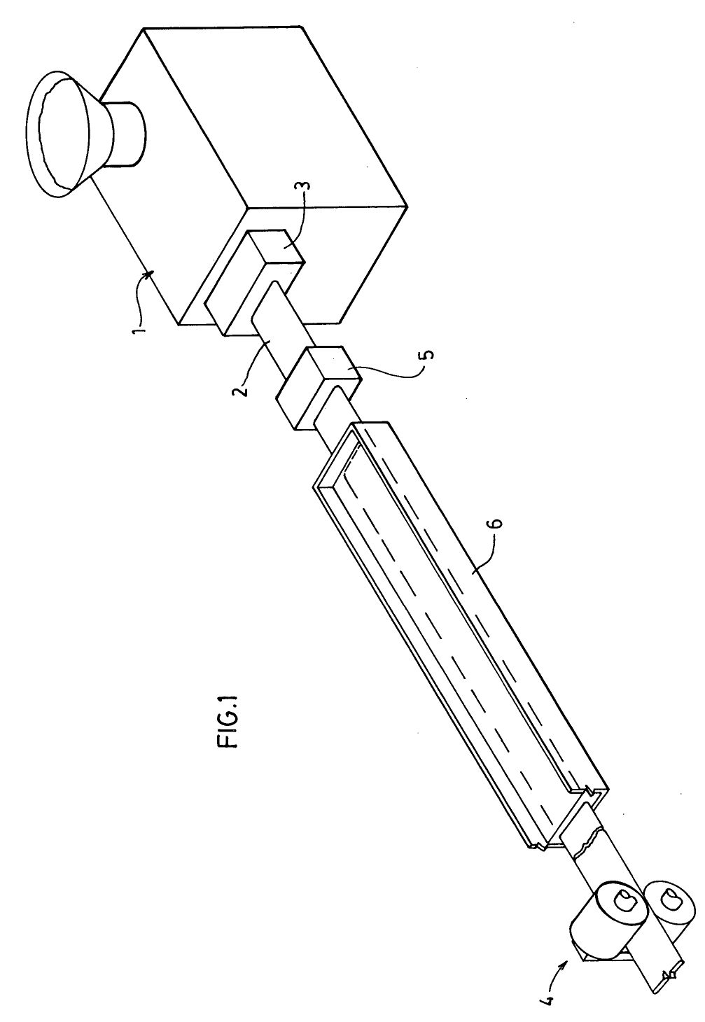

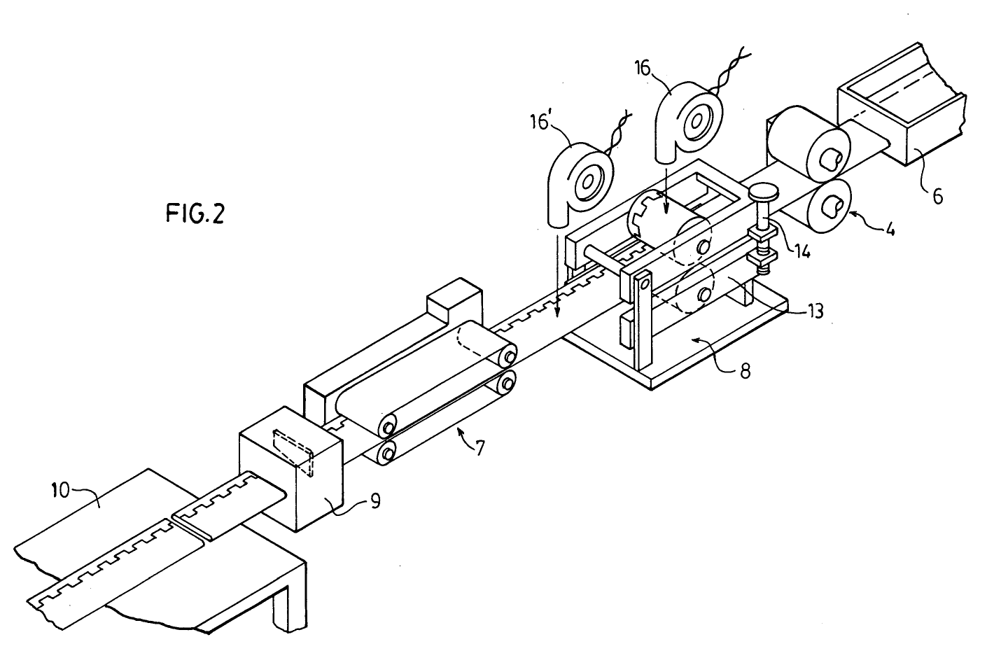

With reference to FIGS. 1 and 2 a conventional extruder 1 is illustrated, the extruder being operated at a temperature between about 300 degrees F. and 360 degrees F. from which a flat strip 2 of foamed plastic is pulled from a die 3, a calibrator 5, a vacuum operated water cooling station 6, and smoothing rollers 4.

The strip 2 is formed from foamed plastic material formulated with sufficient blowing agents to leave some residual unactivated or not fully activated blowing agents in the foamed plastic after the extrusion process. A PVC containing between 0.2 p.p.h. to 0.5 p.p.h. of organic type blowing agents and between 0.5 p.p.h. to 1.2 p.p.h. of inorganic blowing agents has been found very satisfactory.

After passing through the water cooling station 6 as shown in FIG. 2, the extrusion 2 is pulled by a puller 7 between smoothing rollers 4 and through an engraving station generally designated at 8. Following the engraving, the strip 2 is delivered from the puller through a cutting station 9 to be collected on a collector table 10.

The engraving station 8, illustrated in FIG. 2, comprises an upper heated engraving roller 11 and an under supporting roller 12 with the extrusion 2 being fed therebetween. The rollers 11 and 12 are rotatably supported-in a clamping frame 13 which has an adjuster 14 to control the clamping or squeezing pressure of the rollers on the extrusion.

The engraving roller 11 has the desired design, indicated generally at 15, embossed thereon and is heated by a hot air gun 16 to bring the temperature of the roller embossment up to between about 230 degrees F. and 300 degrees F.

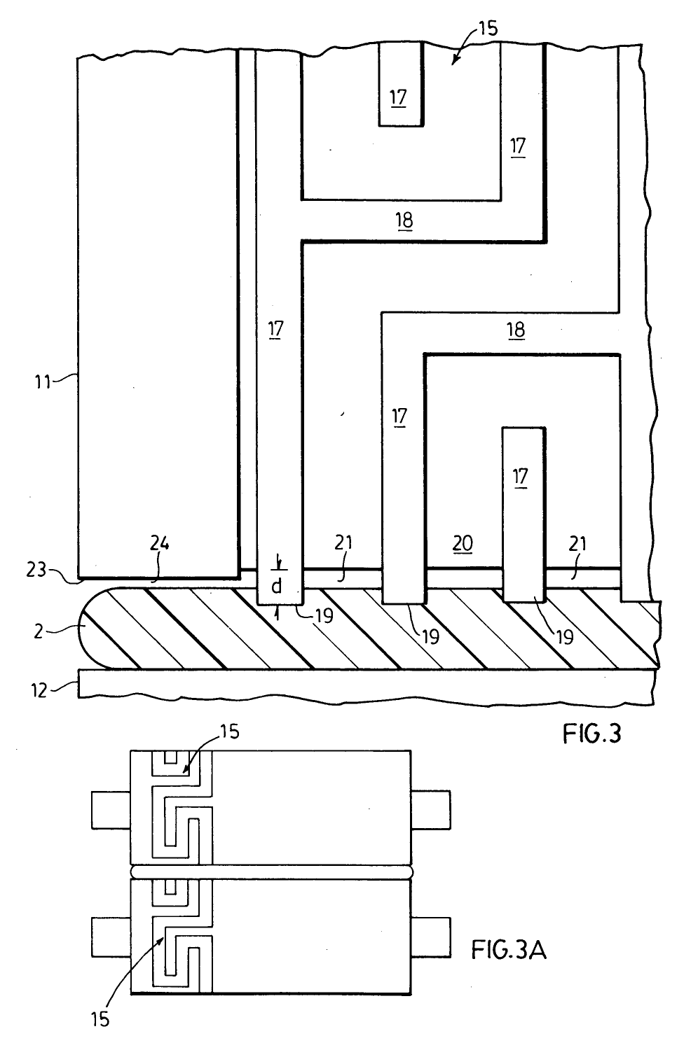

As illustrated in FIG. 3, the particular illustrated design 15 embossed on the engraving roller 11 comprises circumferentially extending projections 17 and projections 18 extending in a direction transversely of the projections 17, that is, parallel to the roller axis.

As can be seen from FIG. 3 these projections project outwardly beyond the body of the roller with their outer surfaces or peaks 19 projecting a distance “d” beyond the body portion 20 of the roller 11.

FIG. 3 illustrates the depth of penetration of the projections 17 and 18 of the embossed engraving roller design 15 during the engraving process. As will be seen, only the peaks 19 and the outer portions adjacent the peaks project into the foamed plastic of the extrusion.

Thus, it will be seen that the depth of penetration of the embossment projections is substantially less than the distance “d” leaving a space 21 between the surface of the extrusion 2 and the body portion 20 of the roller 11.

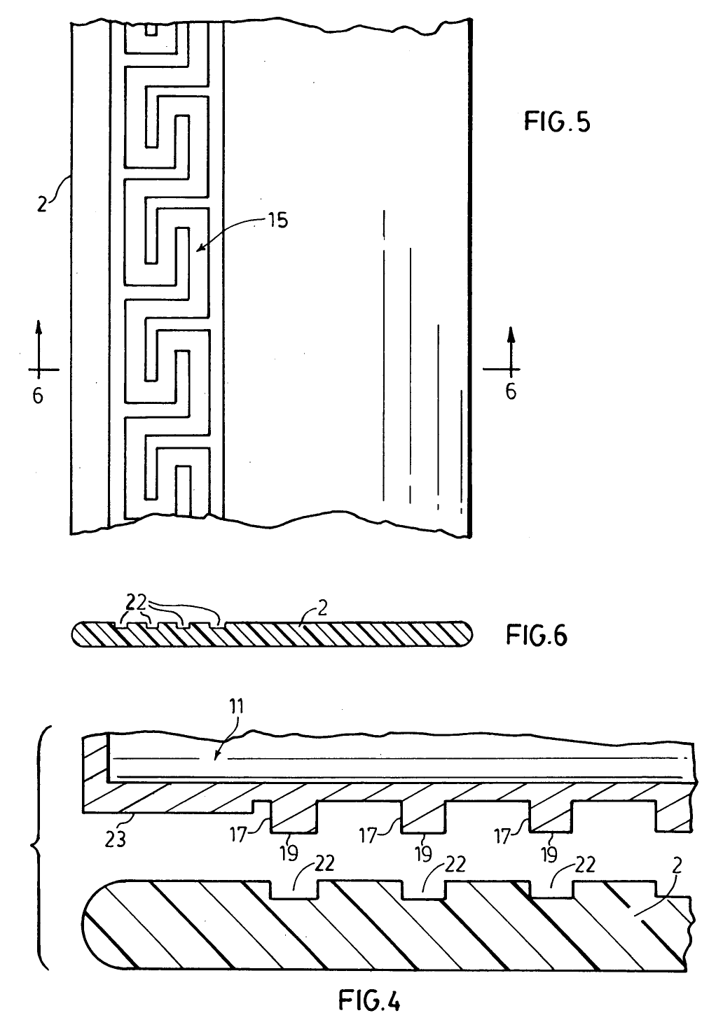

Since the temperature of these projections 17 and 18 is between about 230 degrees F. and 330 degrees F., their heat is sufficient to activate the residual unactivated or activatable blowing agent or agents causing the plastic in these penetrated areas to foam and flow around the penetrating portions of the projections to precisely conform the grooves 22 engraved in the extrusion to the shape of the embossed roller design 15 as shown in FIG. 4.

As shown in FIG. 3, the space 21 left between the extrusion 2 and the body portion 20 of roller 11 during the engraving operation not only prevents contact of this body portion with the extrusion which would cause unwanted activation of residual blowing agents but it further provides an escape route between the roller projections 17 and 18 for the escape of heat trapped between the projections to ensure there is no unwanted blowing agent activation.

Also as shown in FIG. 3, the outer peripheral surface 23 of the roller 11 is also maintained out of contact with the extrusion 2 being separated therefrom by a space 24 which provides for lateral heat escape.

Upon being pulled clear of the engraving roller 11 and under roller 12, the extrusion appears as in FIG. 5 having an engraved design 15′ which is a replica or mirror image of the design 15 embossed on the engraving roller.

It is important to note that where the extrusion 2 is to be used to produce self supporting products which require rigidity such as blind slats or louvers that in addition to ensuring that the activatable blowing agents are only activated by the penetrating portions 17 and 18 of the engraving roller but that the extrusions have adequate thickness and density for its purpose. If any of the residual blowing agents are activated in the non-engraved portions of the extrusion, their density would be reduced. The density of a self supporting slat extrusion is very critical as reduction in the density will drastically reduce the horizontal rigidity or vertical hanging characteristics of the slat. If the density of such a slat extrusion, for example, is reduced below a density between about 45 percent to 55 percent of that of a solid slat extrusion having the same thickness, the slat will show bowing characteristics when exposed to a heat source such as heat build up from the sunlight between the blind and the window or any other type of heat source such as interior baseboard heaters or other sources of heat.

However, engraved products that do not require any form of rigidity because they are secured to rigid surfaces may have much lower densities as well as being thinner. Such products include door moldings or window moldings that are secured in position and serve purely decorative purposes.

In the application of the invention illustrated in FIGS. 1 and 2 the engraved design is adjacent one end of the engraving roller 11 to locate the design near one side of the extrusion 2. The penetrating pressure of the 5 embossments of the engraving roller near one side may cause some distortion or twisting of the extrusion 2 as it leaves the engraving station 8. To ensure no problem is encountered, as illustrated in FIG. 2, a hot air gun 16′ is arranged to direct heat on the extrusion after it leaves the engraving station to heat the extrusion to a temperature of the order of 150 degrees F. to 200 degrees F. Heated to these temperatures, the extrusion is workable by an operator to straighten same. These temperatures are, of course, well below any temperature that would cause any reactivation of any residual unactivated blowing agent.

It will be understood that the engraving roller 11 may have the desired design embossed thereon at any position across its width or even having more that one design engraved thereon. As shown in FIG. 3A, the bottom roller 12 may be replaced by an embossed bottom roller 12′ to produce an engraved design on the undersurface of the extrusion as well as on its top surfaces.

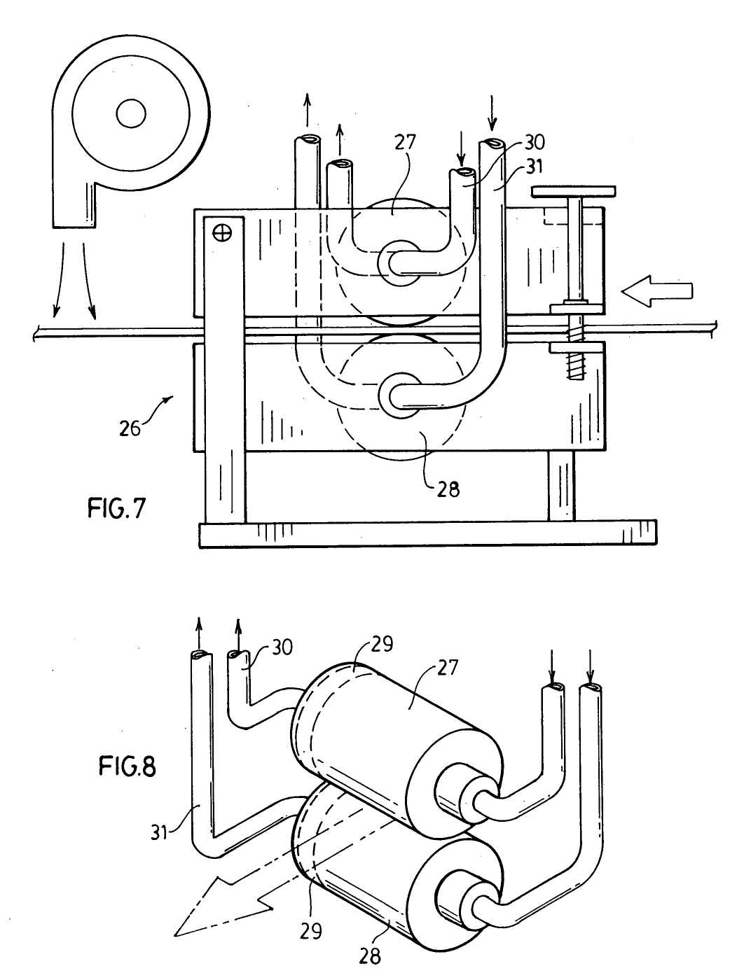

The embossed design on the engraving roller or rollers may be brought up to the blowing agent activating temperature in other ways than with a hot air gun as illustrated in FIG. 7. FIG. 7 shows an engraving station 26 which has an upper engraving roller 27 and a lower engraving roller 28 both with centrally located designs 29 embossed thereon.

In this case, the engraving rollers 27 and 28 are heated by circulating hot oil therethrough by means of piping 30 and 31 respectively. As before, only the hot outer most portions of the embossed designs 29 penetrate into the foamed plastic of the extrusion 3.

It will be understood that the width and thickness of the foamed plastic strip 2 can be selected as desired and, using the principles of the invention as described above, multiple designs can be engraved on the extrusion spaced across its width.

While PVC foamed material has been found to be particularly useful, other materials with similar characteristics or properties, more specifically with “absorbing” type characteristics, such as polystyrene, that can retain the engraving can be used. These or other type materials with similar properties or characteristics can be used with a cap stock or as a cap stock. In this connection, the invention is applicable to engrave an extrusion of a non-foamed materials such as ABS, partially or totally encased in a foamed plastic material to produce a partially engraved product having a reinforcing core.

Although various preferred embodiments of the present invention have been described in detail, it will be appreciated by those skilled in the art that variations may be made utilizing the principles of the invention and without departing from the scope of the appended claims.

The embodiments of the invention in which an exclusive property or privilege is claimed are defined as follows:

1. A method of providing a partially engraved generally flat foamed plastic extrusion having a desired design or pattern occupying only a portion of its width engraved therein, said method comprising extruding a foamable plastic material containing a sufficient amount of blowing agent or agents whereby when said material is extruded it comprises a generally flat foamed plastic extrusion having a residual activatable blowing agent or agents remaining therein, pulling said extrusion between a pair of rollers at least one of which is an engraving roller having intermediate its ends an embossment comprising projections defining said desired design or pattern on said at least one roller, heating said at least one engraving roller to bring said projections up to a temperature of between about 230 degrees F. to 300 degrees F. while squeezing said rollers together to cause outer portions of said hot projections to penetrate the foamed material of said extrusion while leaving all other surfaces of said at least one engraving roller out of contact with the foamed material whereby said penetrating projection portions activate the residual activatable blowing agent or agents where they have penetrated the plastic material to cause the plastic material in such areas to foam and conform around said penetrating projection portions to accurately produce an engraving of said at least one engraving roller design on one side of said extrusion.

2. A method as claimed in claim 1 in which the other of said pair of rollers is also an engraving roller having intermediate its ends a desired design or pattern embossed thereon comprising projections defining said desired design or pattern on said other engraving roller, heating said other roller to bring said other roller projections to a temperature of between about 230° F. and 300° F. and in squeezing said rollers together causing only outer portions of said other roller projections to penetrate said foamed plastic extrusion and foam a residual foaming agent or agents to conform the foamed plastic to the projections of said other engraving roller to reproduce the design or pattern embossed on said other engraving roller on the side of said foamed extrusion opposite to the side engraved by said one engraving roller.

3. A method as claimed in claim 1 or 2 in which said extrusion after being engraved is heated to a temperature sufficient to enable the extrusion to be manipulated to ensure its straightness but below any temperature that would cause any residual foaming agent to be activated.

4. A method as claimed in claim 3 in which said temperature to enable said extrusion to be manipulated is between about 150 degrees F. to 200 degrees F.

5. A method as claimed in claim 1 in which said engraving roller is heated by means of a hot air gun to bring said projections to said temperature between about 230 degrees F. to 300 degrees F.

6. A method as claimed in claim 1 in which said engraving roller is heated by circulating hot oil therethrough to bring said projections to said temperature between about 230 degrees F. to 300 degrees F.

7. A method as claimed in claim 2 in which said engraving rollers are heated by circulating hot oil therethrough to bring said projections to said temperature of about 230 degrees F. to 300 degrees F.

8. A method as claimed in claim 5 or 6 in which said extrusion after being engraved is heated to a temperature of between about 150 degrees F. and 200 degrees F. to enable said engraved extrusion to be manipulated to ensure its straightness.

9, A generally flat foamed plastic extrusion having a selected width, thickness and length and having at least on one side a design or pattern occupying only a portion of the width of the extrusion engraved therein leaving a smooth surfaced border on each side of said engraved design or pattern.

10. A foamed plastic generally flat extrusion having a selected width, thickness and length and having on both sides a design or pattern occupying only a portion of the width of the extrusion engraved therein leaving a smooth surfaced border on each side of said engraved designs or patterns.

11. A foamed plastic extrusions as claimed in claim 10 in which the positions of the designs or patterns engraved on both sides are in registration.

12. A foamed plastic extrusion as claimed in claim 9 or 10 in which said extrusion has a rigidity sufficient to render its self supporting.

13. A foamed plastic extrusion as claimed in claim 12 in which the density of said foamed plastic extrusion is between 45 to 55 percent of the density of a solid plastic extrusion having said selective thickness.
